(19) United States
(12) Patent Application Publication
(10) Pub. No.: US 2026/0052149 A1
(43) Pub. Date: Feb. 19, 2026

(54) SYSTEMS AND METHODS FOR THIRD-PARTY AGENT BROKER AUTOMATIONS

(71) Applicant: Salesforce, Inc., San Francisco, CA (US)

(72) Inventors: William Edward Dressler, II, Stallings, NC (US); Andre Richard Robitaille, San Francisco, CA (US); Henry Tule Akpala, Irvine, CA (US); Joahna Gwynne Kuiper, Portland, OR (US)

(21) Appl. No.: 18/806,134

(22) Filed: Aug. 15, 2024

(51) Int. Cl. H04L 9/40

(52) U.S. Cl. CPC H04L 63/10; H04L 63/0807

(57) ABSTRACT

Techniques (e.g., software, hardware, and/or machine-learned model(s)) may generate a third-party agent broker for validating data access requests on behalf of a resource provider. This third-party agent broker may validate the data access requests against a personalized access model associated with the resource provider. The context of the data access requests may be checked for similarity to the personalized access model (e.g., via embedding the data access request and the personalized access model). The data access requests may then be fulfilled based on validating the context of the data access requests.

### TECHNICAL FIELD

One or more implementations relate to brokering secure and ethical data exchanges involving external artificial intelligence systems or services.

### BACKGROUND

Artificial Intelligence (AI) has become increasingly efficient at simulating human intelligence in order to perform tasks. AI agents are software programs that leverage artificial intelligence techniques in order to act on behalf of an individual. For instance, an AI agent may interact with its environment, collect data within the environment, and use the collected data to perform self-determined tasks to accomplish predetermined goals. That is to say that, while an individual may set such a predetermined goal, an AI agent may autonomously choose actions to perform in order to achieve the goal. AI agents integrate with various external and/or “backend” resources, including Application Program Interfaces (APIs) that connect external applications and services, and databases (e.g., customer databases) potentially including sensitive personal data such as contact information, login information, or the like. Accordingly, data exchanges involving AI agents may present problems including, for example, compromising one or more ethical, legal, privacy, or personal standards.

### BRIEF DESCRIPTION OF THE DRAWINGS

The detailed description is described with reference to the accompanying figures. In the figures, the left-most digit of a reference number identifies the figure in which the reference number first appears. The use of the same reference numbers in different figures indicates similar or identical components or features. The figures are not drawn to scale.

FIG. 1 illustrates a pictorial flow diagram of an example process for responding to a data access request to access one or more resources managed by an external AI service, in accordance with techniques described herein.

FIG. 2 illustrates a pictorial flow diagram of an example process for responding to a first data access request by a first user associated with first permissions and a second data access request by a second user associated with second permissions, in accordance with techniques described herein.

FIG. 3 illustrates a timing diagram depicting an exemplary sequence of communications between a client application, an Agent Broker as a Service (ABaaS) API, and a resource provider.

FIG. 4 illustrates a timing diagram depicting an exemplary sequence of communications suitable for implementation of the subject matter described herein in connection with a chatbot service in accordance with one or more implementations.

FIG. 5 illustrates a flowchart of an example process for performing ABaaS operations, in accordance with one or more implementations.

FIG. 6 illustrates an example system for performing techniques described herein.

### DETAILED DESCRIPTION

The techniques discussed herein may include utilizing software, hardware, and/or machine-learned models to generate a third-party agent broker(s) that may be deployed in a software environment to validate data access requests. In one or more implementations, data access requests may include electronic requests to acquire and perform an action(s) on a specified resource including retrieving, deleting and/or modifying data associated with the specified resource. As a first example, a data access request could be a request to acquire the email address associated with a resource such as an audio streaming service. In a second example, a data access request might be a request to access an organization's network directory. While there may be legitimate reasons for such data access requests (such as, for example, when a virtual assistant requests the email address in order to link a user's audio streaming service account to a home smart speaker), the techniques described herein prevent the validation of illegitimate or otherwise invalid data access requests.

Depending on the implementation, the third-party agent broker can be integrated with or otherwise incorporated as part of an application or be deployed as a separate or standalone process, application programming interface (API), software agent, or the like that is capable of validating data access requests independent of an application. For instance, the techniques may comprise deploying a third-party agent broker to validate data access requests received on behalf of an AI agent. In some examples, the techniques may comprise receiving an indication of a data access request transmitted between a first AI agent and a second AI agent. For instance, the first AI agent (i.e., the requesting AI agent) may transmit a data access request to the second AI agent (i.e., the responding AI agent) directly or indirectly. In some other examples, a first user and a second user (or any other number of users or AI agents acting on behalf of respective users) may each transmit data access requests to a responding AI agent.

Regardless, the techniques discussed herein may include identifying or generating, by the third-party agent broker and on behalf of a responding AI agent, valid access credentials to use as a basis for providing data in response to a data access request. In an instance where the third-party agent broker determines that it is unable to identify or generate valid access credentials, the third-party agent broker may instead deny, reject, or otherwise refrain from fulfilling the data access request.

In one or more implementations, as described in greater detail below, a third-party agent broker utilizes a personalized access model generated using personalized or custom data associated with a particular user, organization or other resource owner to contextualize data access requests. For instance, a user may interact with an interface associated with an application platform to select, indicate, identify, upload, or otherwise provide pieces of data or information associated with the user, organization or resource owner that the third-party agent broker may utilize or employ to validate data access requests. In this manner, the user may select, indicate, identify, upload, provide, or otherwise control which files, documents, data objects, or other data records are maintained on behalf of the user or the user's tenant, organization or other resource owner that the user would like to be utilized or incorporated into the personalized access model.

As an illustrative but non-limiting example involving an organization, Acme organization may enable its corporate privacy policy to be ingested, incorporated or otherwise retrieved (e.g., from a database in which it is stored) by the third-party agent broker to validate data access requests. For instance, Acme organization's privacy policy may outline, describe, or otherwise communicate Acme organization's policies and procedures regarding the collection, use, and disclosure of information associated with an identified or identifiable individual and the choices an identified or identifiable individual may have in regard to such activity. In other words, Acme organization's privacy policy may constitute a binding (e.g., legally and/or ethically) statement explaining how Acme organization collects, uses, and protects personal data. Accordingly, Acme organization's privacy policy may indicate pertinent information regarding the exchange of personal data including, but not limited to, an effective date of the privacy policy, an expiry date of the privacy policy or the like. Additionally, or alternatively, Acme organization may enable other pertinent files and document such as its customer terms of service and/or user terms of service, and legal frequently asked question (FAQs) to be ingested, incorporated or otherwise retrieved by the third-party agent broker to utilize in validating access requests.

By way of an additional example involving an individual user, John Q. Public may enable any of his emails, conversation data (e.g., chat logs, text message logs, call transcripts, comment threads, feeds, etc.) or the like (or any subset thereof) to be ingested, incorporated or otherwise retrieved by the third-party agent broker to validate data access requests. For instance, John Q. Public may desire that his “unsubscribe” emails (i.e., emails opting out of receiving future emails from particular senders) be utilized in validating data access requests. In this regard, the personalized access model captures and provides information that is pertinent to the user or organization (e.g., Acme organization's privacy standards or the like and an John Q.

Public's email communication preferences) and allows the third-party agent broker to respond to data access requests in a manner that comports with such preferences and standards.

Alternatively from, or in addition to indicating which files, documents, data objects, or other data objects the user wishes to incorporate in the personalized access model, the user may identify data records the user wishes to exclude from the personalized access model.

After identifying or obtaining a corpus of user data to be utilized in a personalized access model, the third-party agent broker may generate the personalized access model based on the corpus of user data. For instance, the personalized access model may comprise a vocabulary of words, phrases, phonemes, or the like associated with the user that represents and/or contextualizes the user's data access preferences or policies. The third-party agent broker may tokenize the individual pieces of user data and then generate a corresponding personalized access model for the user that numerically or mathematically represents the corpus of user data. For example, the textual content of a particular file, document, record, transcript, database object or other piece of data associated with the user may be input to an encoder model or other word embedding algorithm to generate a corresponding vector or numerical representation of the textual content. In this regard, in some implementations, the textual content of the particular piece of user data may be lemmatized, normalized, and/or divided into smaller segments prior to tokenization or embedding to improve the relationship between the numerical representation of the respective piece of user data and the semantic and/or syntactic content of that respective piece of user data. The resulting personalized access model for the individual user may thus be realized as a bag-of-words model, word2vec model, or any other suitable model, algorithm or data structure including but not limited to one or more matrices that captures the different numerical or vector representations of the different pieces of user data associated with the user.

In one or more implementations, generating the personalized access model comprises document classification. The third-party agent broker of various implementations may assign categories or classes to documents and other data records to facilitate searching, filtering, analyzing or the like in response to data access requests. For example, the third-party agent broker may utilize language processing (NLP) or other linguistic analysis techniques to classify documents according to a beneficial classification scheme. The third-party agent broker may thus be trained using any suitable training methods (supervised or unsupervised) to correlate text, audio, and/or visual data contained in data records to document classes. In some implementations, a classification scheme includes such document classes as “legal document,” “correspondence,” “confidential,” and “summary document” or any similar classes or sub-classes, though other or different classification schemes are possible. Returning to our above example involving Acme organization, generating Acme organization's personalized access model may include labeling its privacy policy and various terms of service as “legal documents,” while labeling its FAQ's as a “summary document.”

The third-party agent broker of various implementations ascertains a context (e.g., an intended use of the requested resource(s), a condition prompting the data access request, or the like) associated with a data access request to determine the validity of the data access request. In some examples, determining the context associated with the data access request comprises determining one or more attributes associated with a requesting entity including, but not limited to, a relationship between the requesting entity and the one or more resources, an IP address of the requesting entity, etc. In some other examples, in order to determine the context of the data access request, the third-party agent broker may determine one or more contextual attributes such, as a timestamp associated with the data access request.

Thus, the third-party agent broker may be configurable to receive the corpus of data records (i.e., input text data and other textual content associated with a corpus of data records to be utilized in a personalized access model) and then parse or otherwise analyze the textual content using natural (NLP) techniques to identify the context, intent or other action desired by the user based on the content, syntax, structure and/or other linguistic characteristics of the textual content. Likewise, the third-party agent broker may be configurable to parse or otherwise analyze the textual content of data access requests to ascertain a context thereof. For instance, the third-party agent broker may be configurable to determine whether a context of a data access request aligns with an intended use of a requested resource. Based on the context of the data access request and various permissions associated with the various data records associated with the user, the third-party agent broker may identify or otherwise determine what (if any) data associated with the user can be shared.

In some examples, the third-party agent broker may ascertain the context associated with the data access request and/or generate a response to the data access request based at least in part on a document classification of one or more documents in the personalized access model. In this regard, the third-party agent broker may apply an access policy in order to generate a response to the data access request. For instance, the third-party agent broker may apply any suitable access control model including mandatory access control (MAC), discretionary access control (DAC), role-based access control (RBAC), attribute-based access control (ABAC) or the like.

In a first example, an access policy may include approving access to documents labeled as “confidential” only when an IP address associated with the data access request is within a corporate network (i.e., access to confidential records is restricted to in-office requests). Even further to this first example, in-office access to confidential records may be restricted to only users having certain roles (e.g., “attorney” or “executive”). In a second example, an access policy may include approving all data access requests to certain documents, but only in redacted condition. Accordingly, the third-party agent broker of some implementations may apply an access policy of detecting and/or masking any private and/or proprietary information prior to fulfilling a data access request. For example, detecting the private and/or proprietary information may be accomplished by determining data that returns a match to one or more regular expressions or for which a probability determined by a machine-learned model trained to detect private and/or proprietary information meets or exceeds a threshold likelihood. Such a machine-learned model may comprise a neural network or transformer-based machine-learned model and such a model may additionally or alternatively classify the type of data. Once private and/or proprietary information has been detected, the classification determined by the first machine-learned model, a classification associated with a regular expression that determined data that matches the regular expression, and/or the private and/or proprietary information itself may be used as input to another machine-learned model, such as a neural network or transformer-based machine-learned model that may generate masking data of the same type as the private and/or proprietary information. For example, where the private and/or proprietary information was a name, the second machine-learned model may generate a different name, or where the private and/or proprietary information was a phone number or social security number, the second machine-learned model may generate a number having the same format (e.g., XXX-XXX-XXXX or XXX-XX-XXXX) as the input number or as specified by the input to the second machine-learned model.

The techniques described herein provide a technical solution to a problem that is necessarily rooted in computer technology, as the problem of validating data access requests and thereafter generating valid access tokens specifically arises in the realm of computer networks. Particularly, the techniques described herein include configuring machine learning models to perform operations—which cannot practically be performed in the human mind—in order to provide improved network performance. For instance, the disclosed techniques provide network security benefits by preventing potential delays involved in waiting on a network administrator to manually validate data access requests. Further, the disclosed techniques decrease network congestion and latency by limiting the number of devices that are authorized to access data. In this regard, the techniques described herein also optimize database queries by preventing redundant or unnecessary data retrieval.

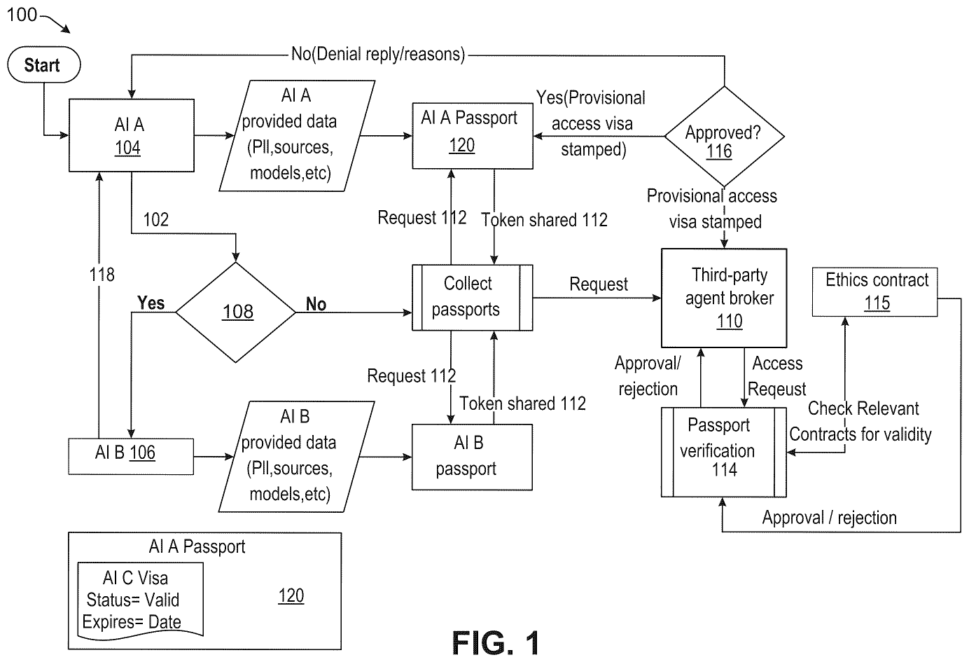

FIG. 1 illustrates a pictorial flow diagram of an example process 100 for responding to a data access request to access one or more resources managed by a resource provider 106 (AI B), in accordance with techniques described herein. As discussed above, the example process 100 may be carried out in a computing environment configurable to deploy and support a third-party agent broker to perform ABaaS functions on behalf of a client such as the resource provider 106. For instance, the resource provider 106 may maintain, on behalf of a user, tenant, organization, or other resource owner, data records entered or created by that resource owner (or other users associated with the resource owner), files, documents, objects, or other electronic information uploaded by the resource owner or otherwise generated (e.g., by one or more computing processes) based on user input. In exemplary implementations, the third-party agent broker 110 is capable of provisioning access to such resources (e.g., over a communications network (not pictured)). Thus, for purposes of explanation, the third-party agent broker 110 facilitates transactions of the resources managed by the resource provider 106 in response to access request(s) received from a requesting AI 104 (AI A). Accordingly, it should be appreciated that FIG. 1 is a simplified representation of exemplary ABaaS functionality according to some implementations and is not intended to be limiting.

In one or more exemplary implementations, the process 100 may begin at operation 102, which may include receiving a data access request. While not explicitly depicted, in practice, a user (or an AI agent on behalf of the user) utilizes a client device to access an instance of a client application executing on the client device to transmit the access request. The client device can be realized as any sort of personal computer, mobile telephone, tablet, or other network-enabled electronic device coupled to a network that executes or otherwise supports a web browser or other client application allowing the user to access one or more GUI displays in order to formulate and transmit the access request. For instance, the client device can include a display device, such as a monitor, screen or another type of electronic display capable of graphically presenting data along with a user input device, such as a touchscreen, keyboard, mouse, directional pad, or the like. Some implementations may support speech recognition including text-to-speech, speech-to-text, in which cases the client device may include an audio input device such as a microphone and an audio output device such as a speaker. In the illustrated example, the user (via the requesting AI 104 (e.g., AI A)) transmits the data access request (e.g., over a communications network using a network protocol such as hypertext transport protocol secure (HTTPS)) to the resource provider 106 (e.g., AI B).

It will be appreciated that, where a computing device is described herein to receive data from another computing device, the data may be received directly from another computing device or may be received indirectly via one or more intermediary computing devices, such as, for example, one or more servers, relays, routers, network access points, base stations, hosts, or the like, which may be referred to herein as a “network.” Similarly, where a computing device is described herein to send data to another computing device, it will be appreciated that the data may be sent directly to another computing device or may be sent indirectly via one or more intermediary computing devices as described just above. Moreover, data may be transmitted, received, or otherwise exchanged as individual “data objects” comprising interrelated data. Data objects may constitute single bits of data or large quantities of interrelated data, such as substantive data (e.g., the underlying content to be conveyed through a communication) and associated metadata (e.g., data not otherwise considered to be substantive data, encompassing characteristics of the substantive data and/or the relevant exchange (e.g., the identity of the user sending the data, the identity of the user receiving the data, the time/date when the data was sent, formatting to be associated with the exchanged substantive data, the file type of the data object, and/or the like). Thus, operation 102 may additionally or alternatively include the data access request being received by the third-party agent broker 110. For example, the third-party agent broker 110 may receive the data access request prior to passing it to the resource provider 106.

The process 100 may continue at operation 108, which may include determining whether a valid authorization token(s) exists to fulfill the data access request. In some examples, the third-party agent broker 110 stores and maintains (e.g., on behalf of the resource provider 106) or otherwise accesses a database containing currently valid access credentials. Accordingly, in an instance that a currently valid authorization token(s) exists to fulfill the data access request (“yes” at operation 108), the data access request is granted or approved and the requesting AI receives a response including the requested resources. When no currently valid authorization token(s) exists (“no” at operation 108), the third-party agent broker 110 initiates a sub-process defined by operations 112, 114, and 116 to dynamically request and validate access credentials from the requesting AI 104. This sub-process continues until the data access request is granted, or in the event that the requested access credentials cannot be validated, the data access request is denied.

At operation 112, the third-party agent broker 110 receives authorization credentials 120 (also referred to hereinafter as a “passport”) from at least the requesting AI 104. For instance, a passport may be a credential identifying permissions (i.e., the requesting AI's 104 permissions to access the one or more requested resources). Accordingly, a passport may indicate at least validity status data and expiry date data. In the depicted example, the passport 120 indicates that AI A 104 possesses a valid access token (referred to herein as a “visa”) for accessing resources maintained by third AI (AI C). In some implementations, the third-party agent broker 110 receives a passport from each the requesting AI 104 and the resource provider 106.

In some implementations, “collecting” passports comprises collecting or receiving the requisite authorization information. In the depicted example, the requesting AI 104 and the resource provider 106 each provide respective authorization information, which may comprise externally shared or connected data (e.g., data available to a respective AI agent via sources/models) and/or internally connected data. For instance, the authorization data may comprise certain personally identifying information (PII)) that can be used to distinguish or identify an individual, including name(s), address(es), phone numbers, social security numbers, driver's license numbers, taxpayer identification numbers, patient identification numbers, financial account numbers (e.g., account numbers associated with bank accounts such as checking account, savings accounts, trading accounts, etc.), credit card numbers and the like. In some examples, PII may be defined by one or more governing and/or regulatory bodies associated with a user/system employing the techniques described herein. In this regard, a passport may be created, maintained and/or provided on behalf of a user. For instance, a passport may be generated subsequent to a user authenticating with a username, email, user ID or the like. In one or more implementations, a passport may be governed by OAuth permission scopes which may be maintained by the resource owner (e.g., an administrator of a particular group-based communication platform).

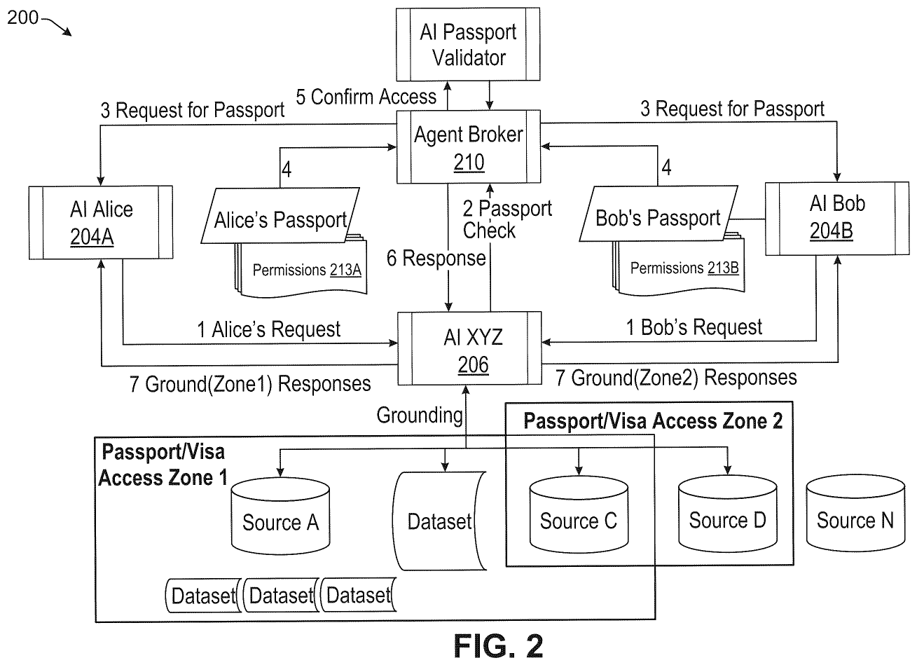

Turning briefly to FIG. 2, illustrated therein is a pictorial flow diagram of an example process 200 for responding to a first data access request received from a first requesting AI 204A (i.e., an AI agent on behalf of a first user Alice) and a second data access request received from a second requesting AI 201B (i.e., an AI agent on behalf of a second user Bob). The first user Alice and/or the first requesting AI 204A may be associated with first permissions 213A. Likewise, the second user Bob and/or the second requesting AI 204B may be associated with second permissions 213B. In some implementations, the first permissions 213A and the second permissions 213B may be role-based permissions. For instance, the first permissions 213A and the second permissions 213B may comprise “minimal” permissions associated with the first user Alice being authorized to perform first actions (e.g., as part of a first role within an organization) and the second user Bob being authorized to perform second actions (e.g., as part of a second role within the organization), respectively. The first permissions 213A and the second permissions 213B may be included in respective “passport” data structures that indicate the permissions granted to or denied the first user Alice and the second user Bob.

Thus, in the depicted example, the process 200 includes a resource provider 206 (AI XYZ) receiving the first data access request (indicated by numeral “1”) and receiving the second data access requested (also indicated by the numeral “1”). It will be appreciated that the first data access request and the second data access request may be received independently and not necessarily simultaneously. In response to the first data access request 202A and the second data access request 202B, the third-party agent broker 210 may filter the data entities 215 accessible depending on permissions granted to a type of user profile and/or an organization associated with the user.

In at least one example, a user profile to which a user authenticates can include permission data associated with permissions of individual users of the platform. In some examples, permissions can be set automatically or by an administrator of the platform, an employer, enterprise, organization, or other entity that utilizes the platform, a team leader, a group leader, or other entity that utilizes the platform for communicating with team members, group members, or the like, an individual user, or the like. Permissions associated with an individual user can be mapped to, or otherwise associated with, an account or profile. In some examples, permissions can indicate which users can communicate directly with other users, which channels a user is permitted to access, restrictions on individual channels, which workspaces the user is permitted to access, restrictions on individual workspaces, and the like. In at least one example, the permissions can support the platform by maintaining security for limiting access to a defined group of users. In some examples, such users can be defined by common access credentials, group identifiers, or the like. Accordingly, in some implementations, the third-party agent broker 210 may generate responses to data access requests based on one or more data partitions 215 (e.g., access zones) based on permissions.

Turning back now to FIG. 1, at operation 114, the third-party agent broker 110 performs a “passport verification” process whereby the third-party agent broker 110 verifies or otherwise confirms that a context associated with the data access request received at operation 102 aligns with the resource owner's corporate governance preferences, social equity preferences, data privacy preferences and/or other parameters or factors indicative of the resource owner's values or beliefs. As described above, this may be accomplished by leveraging the resource owner's personalized access model 115. In the depicted example, the personalized access model 115 comprises an “ethics contract.” For example, an ethics contract may be a mutually agreed obligation between two or more entities that establishes how the two or more entities will resolve issues involving the dissemination of personal data. Such issues may include, for instance, resolving ambiguities associated with data collection practices, what constitutes “consent” or approval to the collection of data or the like.

Accordingly, at operation 114, example process 100 may comprise determining a similarity metric between conversational user input comprising the data access request and one or more instances of data in the personalized access model 115. For example, operation 114 may comprise determining, by an encoder machine-learned model, a first set of embeddings for the data and a second set of embeddings for the conversational user input and determining a similarity metric between the two sets of embeddings. For example, determining the similarity metric may comprise determining a cosine distance between an embedding of the first set of embeddings and an embedding of the second set of embeddings. Additionally or alternatively, determining the similarity metric may comprise determining a set of clusters based at least in part on the first set of embeddings and determining whether an embedding of the second embeddings falls within a cluster, within a threshold distance of a centroid or medoid of a nearest cluster, or the like.

Even still, operation 114 may additionally or alternatively comprise determining whether a threshold percentage of the embeddings of the second set of embeddings have similarity metrics determined for them that meet or exceed a threshold similarity metric for equal to or more than a threshold percentage (e.g., 75%, 80%, any other majority percentage) of the embeddings of the first set of embeddings. If the percentage of the second set of embeddings meets or exceeds a threshold percentage, third-party agent broker 110 searches, queries, or otherwise identifies the data that are most relevant to the received data access request and the process 100 proceeds to operation 116 where the data access request is approved. Otherwise, at operation 116, the data access request is rejected. In this way, the third-party agent broker leverages the resource owner's personalized access model to respond to the data access request.

Accordingly, the process 100 may end at operation 118 which may include responding to the data access request. In some implementations, operation 118 includes providing a denial response including one or more reasons for denial. For instance, a denial response may be configured as a response status code.

Returning to FIG. 2, similar to the process described above with reference to FIG. 1, the process 200 may include determining whether valid access credentials exists to fulfill the first data access request and the second data access request (indicated by the numeral “2”).

The process 200 may further include the third-party agent broker 210 requesting (indicated by numeral “3”) passports (e.g., authentication credentials) from the first user 204A and the second user 204B, such as in an instance where no valid access credentials exist. In this regard, the third-party agent broker 210 may perform one or more authentication protocols. In some implementations, the authentication protocol may be automatically initiated (e.g., via a redirect to a user login page). The third-party agent broker 210 may request authentication via any type of authentication factors including knowledge factors (e.g., a username/password or personal identification number (PIN)), possession factors (e.g., a hardware token, security key, mobile device or the like), inherence (e.g., biometric factors such as fingerprints or facial recognition), location (e.g., IP address authentication), etc.

The process 200 may further include the third-party agent broker 210 receiving (indicated by numeral “4”) passports (e.g., authorization credentials) from the first user 204A and the second user 204B.

The process 200 may include the third-party agent broker 210 verifying or otherwise confirming (indicated by the numeral “5”) that the first user 204A and the second user 204B are authorized to access the requested resources. That is, the third-party agent broker 210 may implement one or more authorization protocols. In the depicted example, the third-party agent broker 210 implements a service-to-service authorization protocol (such as OAuth or the like).

Though, it will be appreciated that the third-party agent broker 210 is not constrained to do so and may implement any other authorization protocol, including lightweight directory access protocol (LDAP) (e.g., in an organizational implementation), or the like. In some examples, the third-party agent broker 210 may implement a protocol for combined authentication and authorization (e.g., via single-sign on (SSO)).

As described above, confirming that the first user 204A and the second user 204B are authorized may further comprise confirming that a respective context associated with each of their data access requests aligns with the resource owner's corporate governance preferences, social equity preferences, data privacy preferences and/or other parameters or factors indicative of the resource owner's values or beliefs.

The process 200 may include the third-party agent broker 210 returning a response (indicated by the numeral “6”) to the resource provider 206. In some examples, the response provided by the third-party agent broker 210 may indicate limited access permissions.

Accordingly, the process 200 may conclude with the resource provider 206 providing a “zone 1” response to the first data access request (indicated by the numeral “7”) and providing a “zone 2” response to the second data access request (also indicated by the numeral “7”). That is, in the depicted example, the resource provider 206 provides access to requested resources that is commensurate in scope with the first permissions 213A and the second permissions 213B. As shown, the first permissions 213A may be associated with access to a first subset of the requested resources (i.e., access zone 1) while the second permissions 213B may be associated with access to a second subset of the requested resources (i.e., access zone 2).

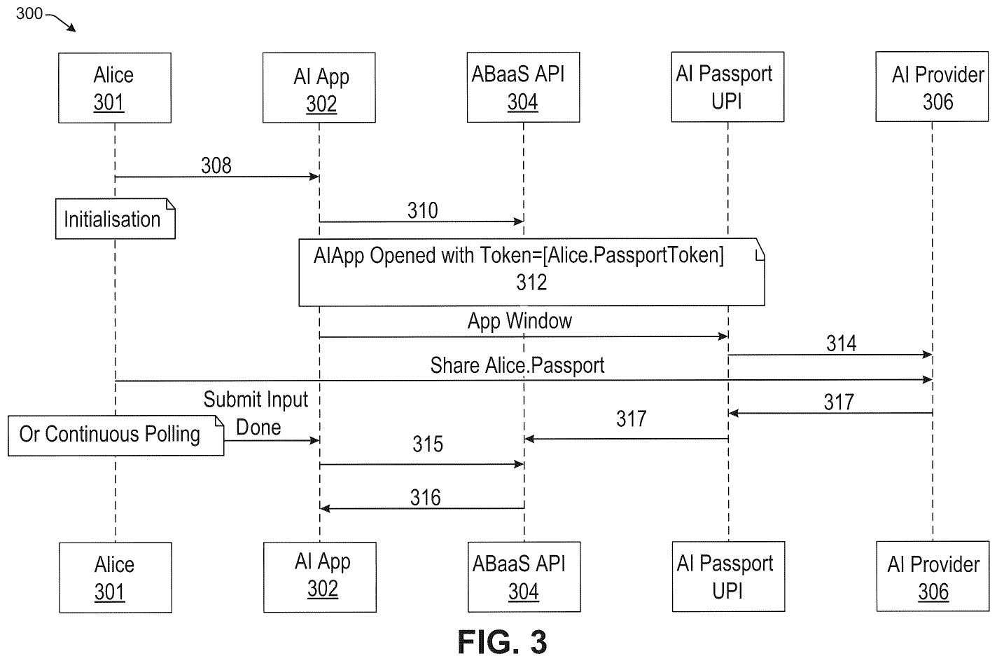

FIG. 3 illustrates a timing diagram depicting exemplary communications 300 between a client application 302, an ABaaS API 304, and a resource provider 306 (such as an AI resource provider, for example). In some examples, the client application 302 may comprise instructions executable by one or more processors to provide a user interface (not shown). For example, the user interface may comprise one or more graphical user interfaces (GUIs), that the instructions may cause to be displayed via an input/output device(s). In one or more implementations, the client application 302 can be an AI application realized as a mobile application, a web application, a database interface (e.g., such as an application that presents a SQL or other database interface), or a desktop application. For instance, the client application 302 may be a gaming, e-commerce, marketing, navigation, customer service or other AI application that might request access to data or other resources in order to perform specific tasks at the direction of and/or on behalf of a user of the AI application.

At operation 308 user 301 (Alice) of the client application 302 at a client device (not shown) may interact with the one or more GUIs (also not shown) that are provided by the client application 302 to initiate or otherwise trigger an API call. The API call may be triggered or otherwise initialized by user action including button or mouse clicks, keyboard strokes representing input of search terms or the like that represent a data access request for which the client application 302 must request a response. In some other examples, the data access request may be triggered or initiated by an external event, such as receiving a notification from another, different application. While the depicted example illustrates use of initialization or continuous polling (also known as long polling), generally, any suitable protocol or methodology for data retrieval may be employed including one or more push-based approaches such as webhooks (also known as “HTTP callbacks” and “reverse API”), and/or one or more pull-based approaches such as API polling (e.g., long polling and/or short polling), and the like.

The ABaaS API 304 may expose back-end functions and/or services hosted by the resource provider 306 to the client application 302 (e.g., via a client device), external computing devices, etc. without transferring the functions/services/software to such computing devices and/or by accomplishing the functions and/or services at the resource provider. As it relates to the instant discussion, this may comprise API(s) for receiving indications from the user 301 (e.g., as part of an API call), the client application 302 and/or a client device associated with the user 301, or from different ones of the components. That is, client application 302 may generate API calls to the ABaaS API 304 and/or any of the components discussed herein may transmit calls to the ABaaS API 304 and/or receive responses from the ABaaS API 304. For instance, and while not explicitly depicted, the client application 302 may transmit the API call over a secure network. In some examples, the client application 302 may interface with the ABaaS API 304 to authenticate the user 301 and grant or deny the user 301 access to data and/or other resources hosted or otherwise maintained by the resource provider 306. Thus, at operation 310, the client application 302 sends or otherwise transmits an API call to the ABaaS API 304. In one or more implementations, the client application 302 passes authorization credentials 312 prior to, immediately prior to, substantially simultaneously with or simultaneously with the API call.

While discussed up to this time in terms of accessing (i.e., retrieving) data or other resources, the ABaaS API 304 may operate to grant or deny any requests made by the client application 302 to interact with or manipulate information including but not limited common API request methods (e.g., GET, POST, PUT, PATCH, DELETE). Operation 314 may accordingly comprise transmitting an API request indicating the type of interaction the user 301 desires to have with the data or resources maintained by the resource provider 306. In this regard, a context associated with the data access request may be determined based at least in part on an underlying API request method. For example, an intended use of the requested data may be determined based on the underlying API request method. In some examples, operation 314 may result from the user 301 authenticating into a tenant system hosted by the resource provider 306. Regardless, at operation 314, the ABaaS API transmits the data access request to the resource provider 306 on behalf of the user 301.

At operation 316, the exemplary communications 300 may comprise the client application 302 retrieving an API response 317 from the ABaaS API 304. For example, the resource provider 306 may, in response to the data access request, return an API response 317 indicating that access to all, some, or none of the requested data is granted. In an example where the user 301 requests access to and is permitted to access n data files, where n is a positive integer, operation 316 may therefore comprise retrieving each of the n data files.

Optionally, at operation 315, the client application 302 may query the ABaaS API 304 for an API response 317 prior to retrieving the API response 317. In some cases, pre-processing the API response may be triggered or initiated by operation 315.

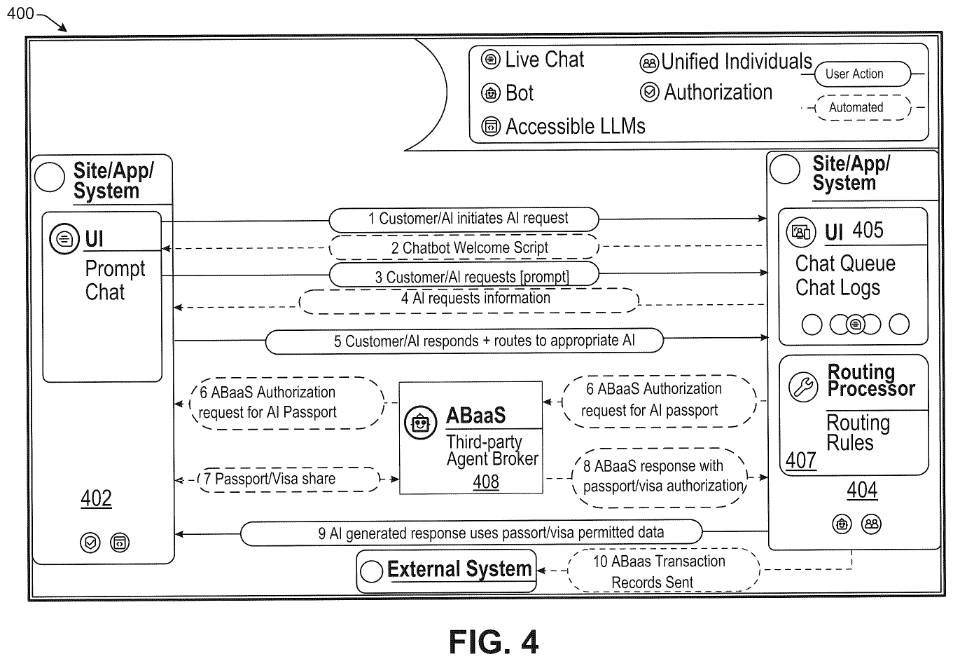

FIG. 4 illustrates a timing diagram depicting an exemplary sequence of communications 400 suitable for implementation of the subject matter described herein in connection with a chatbot service 404 in accordance with one or more implementations. For instance, the ABaaS of one or more implementations may be integrated with, incorporated into, invoked by, or otherwise implemented by the depicted chatbot 404. The ABaaS analyzes conversational user input received by the chatbot service 404 and other data records associated with a particular user to identify or otherwise determine a user objective to perform a particular action in connection with an AI system or service. For instance, a user objective may comprise accessing one or more resources maintained by an external AI system or service (not numbered in order to preserve legibility). Thus, the ABaaS in connection with the chatbot service 404 validates (or invalidates) a context associated with the user objective. After validating the context of the user's objective, and in response to the conversational user input, the ABaaS in connection with the chatbot service 404 automatically generates a corresponding plan or sequence of one or more sub-actions to be performed using the chatbot service 404 and/or other auxiliary services to autonomously perform or achieve the user's objective (e.g., to access and provide the one or more resources maintained by the external AI system).

As depicted, the chatbot 400 may comprise a frontend user interface (UI) layer 405. The front end UI layer may be configured to receive user input, such as user input indicating the user request (or user input from which the chatbot may intelligently infer a user request). In some instances, the front end UI layer may be configured at least to receive text input. The front end UI layer may thus comprise a text input field, a chat interface, a plug-in or the like. In other cases, the front end UI layer may be configured to receive auditory input (e.g., voice commands). Though, any appropriate input modality is contemplated including, but not limited to, mouse clicks (e.g., menu-based or button-based input).

The depicted chatbot 400 also comprises a backend layer 407. The backend layer 407 of may include a conversation management layer. The conversation management layer includes functionality to maintain coherent and logical dialogue between the chatbot and user. For example, the conversation management layer may be configured to perform entity recognition and sentiment analysis. Thus, the conversation management layer of various examples may include functionality to apply routing rules (e.g., via a routing processor) to determine an appropriate AI resource to which to route a user request. To this end, the conversation management layer may maintain and/or access a chat queue and/or chat logs and associated metadata. For instance, the conversation management layer may, in response to a user request, determine chat data including a timestamp associated with a chat, a sender ID associated with the chat, message data associated with the chat, and the like in order to determine an appropriate AI resource. Alternatively, all or some components of the conversation layer may be realized as part of the UI layer 405.

As discussed above, and prior to interacting with the chatbot 404, a user of client application 402 at a client device may interact with one or more GUI displays to configure a personalized access model to be used to ground the chatbot 404. After generating the personalized access model for the particular user, the user subsequently interacts with a GUI display of the client application 402 to interact with the client application 402 and/or the chatbot 404 to input or otherwise provide a conversational user input (indicated by numeral “1”) to the application platform 406 over a network. The client application 402 provides the conversational user input to the chatbot service 404 to trigger or otherwise initialize the chatbot 404. As depicted, in some implementations the chatbot 404 may optionally transmit a welcome script (indicated by numeral “2”) in response to being triggered. In some cases, the chatbot 404 may be automatically called or triggered. In such cases, for example, the chatbot 404 may be called or triggered after determining that a triggering event has occurred. In some examples, a triggering event comprises one or more specific behaviors (e.g., hovering a mouse over a specific location for a threshold amount of time or the like). In other examples a triggering event may include prolonged inactivity (e.g., 20 seconds of inactivity, 30 seconds of inactivity, 40 seconds of inactivity, or the like).

After receiving the welcome script, the user subsequently interacts with the UI of the chatbot 404 to input or otherwise provide conversational user input (depicted by numeral “3”). The conversational user input, which may be provided by the user directly, or may be provided by an AI agent on behalf of the user, comprises the user objective. As described above, in response to receiving the conversational user input, the chatbot 404 performs the same techniques utilized to generate the personalized access model (e.g., tokenization, lemmatization, normalization and/or encoding) to generate a corresponding numerical representation or vector word embedding of the received conversational user input. After generating a numerical representation of the received conversational user input, the chatbot 404 searches, queries or otherwise utilizes the user's personalized access model to identify a subset of the user's data records that are most relevant to the received conversational user input (e.g., using cosine similarity, Euclidean distance, or other mathematical techniques) and then selects, retrieves or otherwise obtains the textual content of the closest data record(s) for supplementing, contextualizing and/or responding to the received conversational user input.

The chatbot (e.g., on behalf of an AI resource) may request additional information of the user (indicated by numeral “4”) in order to ground or otherwise contextualize the user's request. Accordingly, the user (e.g., the client application 402 on behalf of the user) may respond (indicated by numeral “5”) with the requested information. After obtaining the desired amount of supplemental textual content from the user's data records for augmenting the conversational user input, the chatbot service 404 automatically generates a conversational user response incorporating permitted textual content derived from the resource owner's data records and then transmits or otherwise provides (indicated by the numeral “9”) the conversational user response at the client application 402 (e.g., over the network). That is, the chatbot provides the user with a conversational response including data that the user is permitted to access or otherwise consume. In some implementations, providing the conversational user response may include the following suboperations wherein the third-party agent broker 408 authorizes the user to access the requested resources.

The chatbot 404 requests authorization credentials (a “passport”) for the user (indicated by the numeral “6”). For instance, the chatbot 404 may make an intermediate call to the third-party agent broker 408 for authorization credentials that is subsequently passed to the user. Subsequently, the user shares the requisite authorization credentials to the third-party agent broker 408 (indicated by the numeral “7”). The third-party agent broker 408 may then pass the authorization credentials to the chatbot 404 (indicated by the numeral “8”).

Finally, the chatbot 404 may transmit transaction records to the resource owner and/or the external system that maintains the resources. For instance, the transaction records may comprise event data (such as steps taken to complete individual actions, including API calls, database queries, etc.)), time data associated with the events and the like. The chatbot may apply any suitable transaction processing model including local transaction processing, distributed transaction processing (DTP), chained transactions, sagas, and the like.

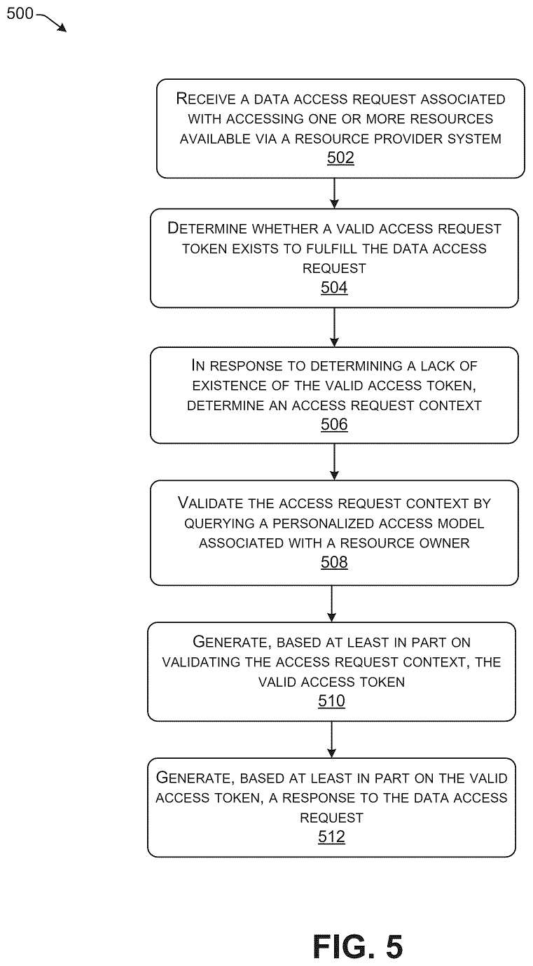

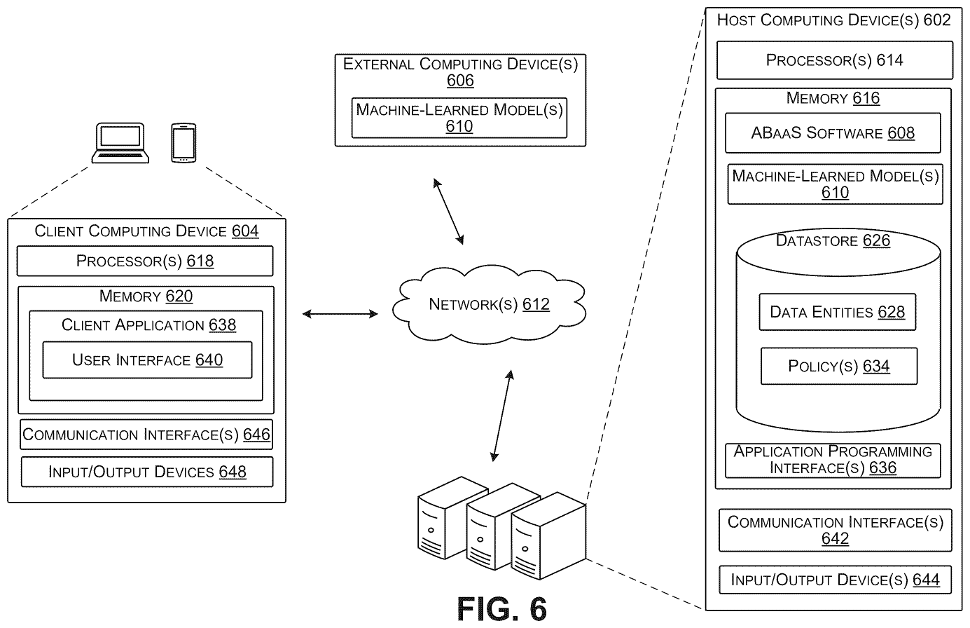

FIG. 5 illustrates a flowchart of an example process 500 for performing ABaaS operations, in accordance with one or more implementations. In some instances, some or all of the process 500 may be performed by one or more components in the environment 600 discussed below with reference to FIG. 6. However, the process 500 is not limited to being performed by the components in the environment 600, and the components in the environment 600 are not limited to performing the process 500.

Referring to FIG. 5, in at least some examples, the process 500 may begin at operation 502, which includes receiving a data access request associated with accessing one or more resources that are available via a resource provider system. As described above, in some examples, operation 502 may include the data access request being received by a third-party agent broker. Moreover, in some examples, operation 502 may include receiving (e.g., by a third-party agent broker) multiple data access requests.

In some examples, at operation 504, the process 500 may include determining whether a valid access request token exists to fulfill the data access request. For instance, operation 504 may include querying a database of currently valid access tokens. In some examples, such a database may be maintained by a third-party agent broker on behalf of the resource provider system.

In some examples, at operation 506, the process 500 may include, in response to determining a lack of existence of the valid access token, determining an access request context. For instance, operation 506 may include determining an intended use of the one or more resources, a condition prompting the data access request, and the like.

In some examples, at operation 508, the process 500 may include validating the access request context by querying a personalized access model associated with a resource owner.

In some examples, at operation 510, the process 500 may include generating, based at least in part on validating the access request context, the valid access token. In some examples, operation 510 may include determining at least an expiry date associated with the validity of the valid access token.

In some examples, at operation 512, the process 500 may include generating, based at least in part on the valid access token, a response to the data access request. In some instances, operation 512 may include providing access to the one or more resources. Still, in some instances, operation 512 may include providing access to requested resources that is commensurate in scope with permissions associated with a requesting entity.

FIG. 6 illustrates an example environment 600 for performing the techniques described herein. The techniques discussed herein may be used in a variety of environments and for a variety of uses, although some examples given herein may discuss an organizational environment wherein data access requests are responded to according to the organization's data privacy policy as one use case because of its ease of explanation. In additional or alternate examples, the computing environment may comprise computing devices used for cybersecurity, search engines, group-based communication, multi-agent/agentic machine-learned model pipeline(s) and/or cluster(s), machine-learned model training, cloud/distributed computing or massive computing efficient data storage and/or retrieval, and/or the like.

In at least one example, the example environment 600 can include one or more computing devices, such as host computing device(s) 602, client computing device(s) 604, and/or external computing device(s) 606. By way of example and not limitation, the host computing device(s) 602 may be representative of servers for hosting the software, hardware, containers, and/or the like to implement at least part of the techniques discussed herein. For example, the host computing device(s) 602 may host (e.g., store and/or execute) ABaaS software 608. The client computing device(s) 604 may be representative of user computing device(s) associated with a first user (i.e., a first “client device”).

The host computing device(s) 602 may comprise one or more individual servers or other computing devices that may be physically located in a single central location or may be distributed at multiple different locations. The host computing device(s) 602 may be hosted privately by an entity administering all or part of the environment 600 (e.g., a utility company, a governmental body, distributor, a retailer, manufacturer, etc.), or may be hosted in a cloud environment, or a combination of privately hosted and cloud hosted services. In some examples, the functional components and/or data discussed herein can be implemented on a single server, a cluster of servers, a server farm or data center, a cloud-hosted computing service, a cloud-hosted storage service, and so forth, although other computer architectures can additionally or alternatively be used. Moreover, the host computing device(s) 602 may comprise hardware and/or software containers accessible to different tenants with access to the host computing device(s) 602.

The computing device(s) 604 and/or 606 may be any suitable type of computing device, e.g., portable, semi-portable, semi-stationary, or stationary. In some examples, the external computing device(s) 606 may comprise one or more individual servers or other computing devices that may host at least some of the machine-learned model(s) 610 in an example where not all of the machine-learned model(s) 610 are hosted by the host computing device(s) 602. Though, in some examples, the machine-learned model(s) 610 may be entirely hosted by the host computing device(s) 602 or the external computing device(s) 606. Some examples of computing device(s) 604 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. In some examples, the client computing device(s) 604 may comprise distributed computing devices, server(s), etc.

In some examples, the host computing device(s) 602, client computing device(s) 604, and/or external computing device(s) 606 may be configured to transmit network packages therebetween via network(s) 612. The network(s) 612 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, cellular network,, or any other such network, or any combination thereof. The network(s) 612 may comprise a single network or collection of networks, such as the Internet, a corporate intranet, a virtual private network (VPN), a local area network (LAN), personal area network (PAN), metropolitan area network (MAN), a wireless local area network (WLAN), a cellular network, a wide area network (WAN), a metropolitan area network (MAN), or a combination of two or more such networks, over which the client computing device(s) 604 and/or external computing device(s) 606 may transmit a query to and/receive an output from the machine-learned model(s) 610 or communicate with other user computing device(s) (e.g., via a communication platform such as a group-based communication platform). Components used for such communications can depend at least in part upon the type of network, the environment selected, or both. Further, the network(s) 612 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the communication platform. In some embodiments, the protocol is a custom protocol of JSON objects sent via a Websocket channel. In some embodiments, the protocol is JSON over RPC, JSON over REST/HTTP, and the like.

Each of the computing devices described herein may include one or more processors and/or memory. Specifically, in the illustrated example, host computing device(s) 602 include processor(s) 614 and memory 616 and client computing device(s) 604 include processor(s) 618 and memory 620.

By way of example and not limitation, the processor(s) 614 and/or 618 may comprise one or more central processing units (CPUs), graphics processing units (GPUs), tensor processing units (TPUs), field-programmable gate arrays (FPGAs), and/or process-acceleration devices such as application-specific integrated circuits (ASICs) or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory 616 and/or 620 may comprise one or more non-transitory computer-readable media and may store software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/flash-type memory, RAM, ROM, EEPROM, flash memory, optical storage, solid state storage, magnetic tape, magnetic disk storage, RAID storage systems, storage arrays, network attached storage, storage area networks, cloud storage, or any other medium for storing information. The architectures, systems, and individual elements described herein may include many other logical, programmatic, and physical components, of which those shown in the accompanying figures are merely examples that are related to the discussion herein. The memory 616 and/or 620 can be used to store any number of software/functional components that are executable by the processor(s) 614 and/or 618, respectively. In many implementations, these functional components comprise instructions or programs that are executable by the processor(s) 614 and/or 618 and that, when executed, specifically configure the processor(s) 614 and/or 618 to perform the actions attributed to the machine-learned model(s) 610 (e.g., a third-party agent broker utilizing machine learning techniques), host computing device(s) 602, and/or client computing device(s) 604, according to the discussion herein.

For example, host computing device(s) 602 may comprise a memory 616 storing the ABaaS software 608, which may comprise any software component(s) that are to be employed to validate data access requests according to the techniques discussed herein. For example, in a cybersecurity development and production environment, the software component(s) may comprise a security information and event management (SIEM) component, a configuration and asset information management component, an endpoint detection and response (EDR) component, an intrusion detection system (IDS), an intrusion prevention system (IPS), a data loss prevention (DLP) component, an identity and access management (IAM) component, a network security monitoring (NSM) component, a threat intelligence platform (TIP), and/or the like. In a human resources environment, the software component(s) may comprise an onboarding and offboarding component(s), a payroll component, a performance management component and/or the like.

In some examples, the host computing device(s) 602 may comprise a memory 616 storing the machine-learned model(s) 610 discussed herein. In some examples, the machine-learned model(s) 110 may be stored and executed at the host computing device(s) 602 and/or external computing device(s) 606. In some examples, the machine-learned model(s) 610 may comprise a machine-learned model for performing clause identification and/or extraction on source data. Such a machine-learned model may comprise a name entity recognition component, an autoencoder, paragraph boundary detection component, a conditional random fields (CRF) component, or the like. Depending on the type of clause(s) determined, the statistical characteristic component may additionally or alternatively determine a document classification and/or apply an access policy in response to a data access request.

In some examples, the machine-learned model(s) 610 may additionally or alternatively comprise a machine-learned model, such as a neural network or transformer-based machine-learned model, such as a large-language model (LLM), that detects and/or masks private and/or proprietary information. For example, private data may include phone numbers, names, personal address(es), social security numbers, or the like. Proprietary information may comprise information like financial data, trade secrets, potential sales, and even the name of a company in some contexts. The machine-learned model may detect that such data exists and may generate data of a similar type to replace the private or proprietary information. For example, if a name is detected, such data may be replaced with a string of characters that maintains a same formatting so as to reduce computational overhead but obscures the original name (e.g., where the original name is “John Q. Public,” the machine-learned model may generate a string of fourteen characters like “XXXXXXXXXXXXXX”). Similarly, if a phone number is detected, the machine-learned model may generate a new number in the same format or may scramble the original phone number, preserving the format of the original data. Such as machine-learned model may comprise a transformer-based machine-learned model, such as an LLM like a generative pre-trained transformer (GPT) 3.5, bidirectional encoder representations from transformers (BERT), Fairseq, XLNet, T5, or the like; and/or a neural network, such as a long short-term memory (LSTM) memory, convolutional neural network, gated recurrent units (GRUs), sequence-to-sequence (Seq2Seq) models, capsule network(s), and/or the like.

In some examples, the machine-learned model(s) 610 may additionally or alternatively comprise a machine-learned model that tokenizes data, i.e., breaks up input data into smaller parts, and encodes these tokens as embeddings. For example, such a machine-learned model may comprise an encoder portion of a transformer-based machine-learned model (e.g., a component that uses layer(s) of self-and/or cross-attention) to determine the embedding. Additionally or alternatively, an encoder may comprise the encoder portion of a BERT model, the encoder portion of a GPT 3.5 model, Ada2, singular value decomposition (SVD), a VGG network, global vectors for word representation (GloVe), Word2Vec, t-distributed stochastic neighbor embedding (t-SNE), or the like. An embedding may comprise a vector or tensor representation of the input data in a high-dimensional space, where distance in the embedding space represents differentiation in characteristics between data sets projected into the embedding space. However, the dimensionality of an embedding may still be lower than a dimensionality of the original data used to generate an embedding. Such an embedding may be determined as an intermediate part of generating the personalized access model discussed herein and/or may be used to determine a similarity between source data within the personalized access model and a data access request, as discussed herein.

In some examples, any of the machine-learned model(s) 610 discussed herein may be pre-trained using general language data and/or may be trained on a training dataset from production data using supervised, semi-supervised, or unsupervised learning. In at least one example, the training dataset used herein may comprise semi-supervised or supervised labels of a field being associated with an event or not (e.g., field contains proprietary information, field contains private information, field data to be processed according to an access policy). The ML model may be run with the training dataset and produces a result, which is then compared with a target, for each input vector in the training dataset. Based on the result of the comparison and the specific learning algorithm being used, the parameters of the model may be adjusted according to gradient descent to reduce a loss determined based at least in part on the comparison. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's parameters (e.g., weights, biases, B-spline parameters and/or weights). In some examples, the host computing device(s) 602 may train the machine-learned model(s) 610.

In some examples, one or more of the machine-learned model(s) 610 may be part of one or more pre-processing component(s) and/or post-processing component(s) discussed herein (not shown to preserve legibility). For example, the pre-processing component(s) may comprise software, hardware, and/or machine-learned model(s) for programmatically determining linguistic characteristic(s) of source data, tokenizing the source data and/or the like. The post-processing component(s) may comprise software, hardware, and/or machine-learned model(s) for determining a similarity metric between context data associated with a data access request and the source data and the like.

The memory 616 may additionally or alternatively comprise a portion of memory 616 (e.g., one or more memories or a portion of a single memory) that collectively forms a datastore 626 (e.g., a database) that stores data entities 628 and/or policy(s) 634. A data entity may comprise content and a data type that identifies a file format, data structure format, or a portion of a file or data structure (e.g., a field) of the particular data entity, and/or a document classification. The content may comprise any type of data, such as text, audio, an image, a document file, a data structure, a database, and/or the like. Accordingly, the data entities 628 may differ depending on the environment 600 in which the techniques discussed herein are deployed. In a patient rights management example, the data entities 628 may comprise things like case(s) (e.g., data structures indicating various data recording interactions with a medical patient such as messages sent between external computing device(s) 606 and the client computing device(s) 604 and/or host computing device(s) 602, digital interactions of the external computing device(s) 606 with a website hosted by the host computing device(s) 102), clinical notes (e.g., a patient status including treatment progress, data/content added to a case data structure), a message (e.g., a telehealth chat transcript, email confirming an appointment), document(s) (e.g., a hospital privacy policy, an insurance invoice, a prescription), and/or other file(s), such as image(s) (e.g., x-rays or MRIs), audio, and/or the like.

The memory 616 may additionally or alternatively store application programming interface(s) (API(s) 636), hypervisor(s), container orchestration system(s), an operating system, and/or container (unillustrated). In some examples, software executed at the client computing device(s) 604, such as a client application 638, may generate API call(s) to the API(s) 636 and/or any of the component(s) discussed herein may transmit call(s) to the API(s) 636 and/or receive responses from the API(s) 636. For example, a user interface 640 executed by a client application 638 may display actuatable/selectable options to indicate data files based on which to generate the personalized access model, a number of personalized access models to generate, particular field(s) of a data file from which to generate the personalized access model, and/or the like. In some examples, the client application 638 may interface with the API(s) 636 to authenticate a user and grant or deny the user access to a portion of the datastore 626 and/or ABaaS software 608.

The memory 616 may additionally or alternatively include an operating system and/or container. In some examples, one or more containers may be instantiated by a cloud orchestrator and may run the operating system and may execute one or more instances of the API(s) 636, machine-learned model(s) 610, pre-processing component(s) 622, post-processing component(s) 624, and/or ABaaS software 608 and may permit access to a portion of the datastore 626 according to permissions associated with a user and/or an organization associated with the container. In some examples, deploying the third-party agent broker(s) discussed herein may comprise granting access to a portion of the datastore 626 containing the personalized access model discussed herein to a container running ABaaS software 608. In an additional or alternate example, the API(s) 636, machine-learned model(s) 610, pre-processing component(s) 622, post-processing component(s) 624, and/or ABaaS software 608 may run in one or more virtual machines or natively on the host computing device(s) 602. In at least one example, the operating system can manage the processor(s), memory, hardware, software, etc. of the host computing device(s) 602.

In some examples, the host computing device(s) 602 may further comprise communication interface(s) 642, which can include one or more interfaces and hardware components for enabling communication with various other devices (e.g., the user computing device 604), such as over the network(s) 612 or directly. In some examples, the communication interface(s) 642 can facilitate communication via WebSockets, APIs (e.g., using API calls), Hypertext Transfer Protocols (HTTPs), etc. The host computing device(s) 602 can further be equipped with various input/output devices 644 (e.g., I/O devices). Such I/O devices 644 can include a display, various user interface controls (e.g., buttons, joystick, keyboard, mouse, touch screen, etc.), audio speakers, connection ports, and so forth.
A: A system comprising: one or more processors; and one or more non-transitory computer-readable media that, when executed by the one or more processors, cause the one or more processors to perform operations comprising receiving a data access request that is associated with accessing one or more resources available via a resource provider system; determining whether a valid access token exists to fulfill the data access request; in response to determining a lack of existence of the valid access token, determining an access request context; validating the access request context by querying a personalized access model associated with a resource owner of the one or more resources; generating, based at least in part on validating the access request context, the valid access token; and generating, based at least in part on the valid access token, a response to the data access request.
B: The system of paragraph A, wherein validating the access request context further comprises: determining first embeddings associated with the personalized access model; determining second embeddings associated with the data access request; and determining that a similarity metric between the first embeddings and the second embeddings satisfies a threshold similarity metric.
C: The system of paragraph A, wherein the data access request comprises a request to one of retrieve data associated with the one or more resources, modify the data associated with the one or more resources, or delete the data associated with the one or more resources.
D: The system of paragraph A, wherein determining the access request context comprises determining one or more of a timestamp associated with the data access request, a relationship between a requesting entity and the one or more resources, and an Internet Protocol (IP) address of the requesting entity.
E: The system of paragraph A, wherein the personalized access model is generated based at least in part on one or more of a privacy policy, a data storage policy, terms of service, and a confidentiality order.
F: The system of paragraph A, wherein validating the access request context further comprises: determining a document classification of a document in the personalized access model; determining an access policy based at least in part on the document classification of the document; and wherein generating the response to the data access request is based further on the access policy.
G: The system of paragraph F, wherein the access policy is one of attribute-based access, role-based access, or discretionary access.
H: A method, implemented at least in part by one or more computing devices, the method comprising: receiving a data access request that is associated with accessing one or more resources available via a resource provider system; determining whether a valid access token exists to fulfill the data access request; in response to determining a lack of existence of the valid access token, determining an access request context; validating the access request context by querying a personalized access model associated with a resource owner of the one or more resources; generating, based at least in part on validating the access request context, the valid access token; and generating, based at least in part on the valid access token, a response to the data access request.
I: The method of paragraph H, wherein validating the access request context further comprises: determining first embeddings associated with the personalized access model; determining second embeddings associated with the data access request; and determining that a similarity metric between the first embeddings and the second embeddings satisfies a threshold similarity metric.
J: The method of paragraph H, wherein the data access request comprises a request to one of retrieve data associated with the one or more resources, modify the data associated with the one or more resources, or delete the data associated with the one or more resources.
K: The method of paragraph H, wherein determining the access request context comprises determining one or more of a timestamp associated with the data access request, a relationship between a requesting entity and the one or more resources, and an Internet Protocol (IP) address of the requesting entity.
L: The method of paragraph H, wherein the personalized access model is generated based at least in part on one or more of a privacy policy, a data storage policy, terms of service, and a confidentiality order.
M: The method of paragraph H, wherein validating the access request context further comprises: determining a document classification of a document in the personalized access model; determining an access policy based at least in part on the document classification of the document; and wherein generating the response to the access request is based further on the access policy.
N: The method of paragraph M, wherein the access policy is one of attribute-based access, role-based access, or discretionary access.
O: One or more non-transitory computer-readable media storing instructions that, when executed by one or more processors, cause the one or more processors to perform operations comprising: receiving a data access request that is associated with accessing one or more resources available via a resource provider system; determining whether a valid access token exists to fulfill the data access request; in response to determining a lack of existence of the valid access token, determining an access request context; validating the access request context by querying a personalized access model associated with a resource owner of the one or more resources; generating, based at least in part on validating the access request context, the valid access token; and generating, based at least in part on the valid access token, a response to the data access request.
P: The one or more non-transitory computer-readable media of paragraph O, wherein validating the access request context further comprises: determining first embeddings associated with the personalized access model; determining second embeddings associated with the data access request; and determining that a similarity metric between the first embeddings and the second embeddings satisfies a threshold similarity metric.
Q: The one or more non-transitory computer-readable media of paragraph O, wherein the data access request comprises a request to one of retrieve data associated with the one or more resources, modify the data associated with the one or more resources, or delete the data associated with the one or more resources.
R: The one or more non-transitory computer-readable media of paragraph O, wherein determining the access request context comprises determining one or more of a timestamp associated with the data access request, a relationship between a requesting entity and the one or more resources, and an Internet Protocol (IP) address of the requesting entity.
S: The one or more non-transitory computer-readable media of paragraph O, wherein the personalized access model is generated based at least in part on one or more of a privacy policy, a data storage policy, terms of service, and a confidentiality order.
T: The one or more non-transitory computer-readable media of paragraph O, wherein validating the access request context further comprises: determining a document classification of a document in the personalized access model; determining an access policy based at least in part on the document classification of the document, the access policy being one of attribute-based access, role-based access, or discretionary access; and wherein generating the response to the data access request is based further on the access policy.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

While one or more examples of the techniques described herein have been described, various alterations, additions, permutations and equivalents thereof are included within the scope of the techniques described herein. For example, articles such as “a,” “an,” or “the” should be construed as being one or more elements. Moreover, a set should be construed as 0, 1, or more elements, given that a set may be an empty set (i.e., a set comprising zero elements), a singleton (i.e., a set comprising a single element), or a set comprising multiple elements (i.e., a set comprising two or more elements). Moreover, it should be appreciated that the term “subset” describes a proper subset. A proper subset of set is a portion of the set that is not equal to the set. For example, if elements A, B, and C belong to a first set, a subset including elements A and B is a proper subset of the first set. However, a subset including elements A, B, and C is not a proper subset of the first set.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types. Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

What is claimed is:

1. A system comprising:
one or more processors; and
one or more non-transitory computer-readable media that, when executed by the one or more processors, cause the one or more processors to perform operations comprising:
receiving a data access request that is associated with accessing one or more resources available via a resource provider system;
determining whether a valid access token exists to fulfill the data access request;
in response to determining a lack of existence of the valid access token, determining an access request context;
validating the access request context by querying a personalized access model associated with a resource owner of the one or more resources;
generating, based at least in part on validating the access request context, the valid access token; and
generating, based at least in part on the valid access token, a response to the data access request.

2. The system of claim 1, wherein validating the access request context further comprises:
determining first embeddings associated with the personalized access model;
determining second embeddings associated with the data access request; and
determining that a similarity metric between the first embeddings and the second embeddings satisfies a threshold similarity metric.

3. The system of claim 1, wherein the data access request comprises a request to one of retrieve data associated with the one or more resources, modify the data associated with the one or more resources, or delete the data associated with the one or more resources.

4. The system of claim 1, wherein determining the access request context comprises determining one or more of a timestamp associated with the data access request, a relationship between a requesting entity and the one or more resources, and an Internet Protocol (IP) address of the requesting entity.

5. The system of claim 1, wherein the personalized access model is generated based at least in part on one or more of a privacy policy, a data storage policy, terms of service, and a confidentiality order.

6. The system of claim 1, wherein validating the access request context further comprises:
determining a document classification of a document in the personalized access model;
determining an access policy based at least in part on the document classification of the document; and
wherein generating the response to the data access request is based further on the access policy.

7. The system of claim 6, wherein the access policy is one of attribute-based access, role-based access, or discretionary access.

8. A method, implemented at least in part by one or more computing devices, the method comprising:
receiving a data access request that is associated with accessing one or more resources available via a resource provider system;
determining whether a valid access token exists to fulfill the data access request;
in response to determining a lack of existence of the valid access token, determining an access request context;
validating the access request context by querying a personalized access model associated with a resource owner of the one or more resources;
generating, based at least in part on validating the access request context, the valid access token; and
generating, based at least in part on the valid access token, a response to the data access request.

9. The method of claim 8, wherein validating the access request context further comprises:
determining first embeddings associated with the personalized access model;
determining second embeddings associated with the access request; and
determining that a similarity metric between the first embeddings and the second embeddings satisfies a threshold similarity metric.

10. The method of claim 8, wherein the data access request comprises a request to one of retrieve data associated with the one or more resources, modify the data associated with the one or more resources, or delete the data associated with the one or more resources.

11. The method of claim 8, wherein determining the access request context comprises determining one or more of a timestamp associated with the data access request, a relationship between a requesting entity and the one or more resources, and an Internet Protocol (IP) address of the requesting entity.

12. The method of claim 8, wherein the personalized access model is generated based at least in part on one or more of a privacy policy, a data storage policy, terms of service, and a confidentiality order.

13. The method of claim 8, wherein validating the access request context further comprises:
determining a document classification of a document in the personalized access model;
determining an access policy based at least in part on the document classification of the document; and
wherein generating the response to the access request is based further on the access policy.

14. The method of claim 13, wherein the access policy is one of attribute-based access, role-based access, or discretionary access.

15. One or more non-transitory computer-readable media storing instructions that, when executed by one or more processors, cause the one or more processors to perform operations comprising:
receiving a data access request that is associated with accessing one or more resources available via a resource provider system;
determining whether a valid access token exists to fulfill the data access request;
in response to determining a lack of existence of the valid access token, determining an access request context;
validating the access request context by querying a personalized access model associated with a resource owner of the one or more resources;
generating, based at least in part on validating the access request context, the valid access token; and
generating, based at least in part on the valid access token, a response to the data access request.

16. The one or more non-transitory computer-readable media of claim 15 wherein validating the access request context further comprises:
determining first embeddings associated with the personalized access model;
determining second embeddings associated with the data access request; and
determining that a similarity metric between the first embeddings and the second embeddings satisfies a threshold similarity metric.

17. The one or more non-transitory computer-readable media of claim 15, wherein the data access request comprises a request to one of retrieve data associated with the one or more resources, modify the data associated with the one or more resources, or delete the data associated with the one or more resources.

18. The one or more non-transitory computer-readable media of claim 15, wherein determining the access request context comprises determining one or more of a timestamp associated with the data access request, a relationship between a requesting entity and the one or more resources, and an Internet Protocol (IP) address of the requesting entity.

19. The one or more non-transitory computer-readable media of claim 15, wherein the personalized access model is generated based at least in part on one or more of a privacy policy, a data storage policy, terms of service, and a confidentiality order.

20. The one or more non-transitory computer-readable media of claim 15, wherein validating the access request context further comprises:
determining a document classification of a document in the personalized access model; and
determining an access policy based at least in part on the document classification of the document, the access policy being one of attribute-based access, role-based access, or discretionary access; and
wherein generating the response to the data access request is based further on the access policy.
